(19) United States
(12) Patent Application Publication
(10) Pub. No.: US 2018/0118371 A1
(43) Pub. Date: May 3, 2018

(54) Improved Means And Mechanism For The Remote Opening Of An Aircraft Cockpit Door In The Event That The Occupant Or Occupants Improperly Do Not Grant Access And For Assuming Aircraft Control Including Alternative Air Traffic Control Alert

(71) Applicant: DAVID RUDICH, Los Angeles, CA (US)

(72) Inventor: DAVID RUDICH, Los Angeles, CA (US)

(21) Appl. No.: 15/563,894

(22) PCT Filed: Mar. 28, 2016
(86) PCT No.: PCT/US16/24441

§ 371 Date: Oct. 2, 2017

Related U.S. Application Data
(60) Provisional application No. 62/142,749, filed on Apr. 3, 2015.
(60) Provisional application No. 62/145,835, filed on Apr. 10, 2015.
(60) Provisional application No. 62/149,420, filed on Apr. 17, 2015.
(60) Provisional application No. 62/172,407, filed on Jun. 8, 2015.

(51) Int. Cl. B64D 45/00; B64C 1/14

(52) U.S. Cl. CPC B64D 45/0015; B64C 1/1469; B64D 2045/0045; B64D 2045/0055; B64D 2045/0035

(57) ABSTRACT

A system for providing security of an aircraft in flight by providing a signal transmitted to all Air Traffic Control facilities within transmission range of the aircraft that emergency access to the cockpit is required and a unique time stamped signal generated by an Air Traffic Control facility to allow access to the cockpit or assume control of the aircraft flight control path in response to analysis of video/audio signals by the Air Traffic Control facility from cameras disposed in the passenger, galley and cockpit areas of the aircraft which are activated by the unique signal from the Air Traffic Control facility.

This application is a non-provisional application which claims the benefit and filing date of provisional application Ser. No. 62/142,749, filed Apr. 3, 2015 for “Means and Mechanism for the Remote Opening of an Aircraft Cockpit Door in the Event that the Occupant or Occupants Improperly Do Not Grant Access”; and provisional application Ser. No. 62/145,835, filed Apr. 10, 2015 for “Improved Means and Mechanism For The Remote Opening Of An Aircraft Cockpit Door In The Event That The Occupant Or Occupants Improperly Do Not Grant Access”; and provisional application Ser. No. 62/149,420, filed Apr. 17, 2015 for “Means and Mechanism For The Remote Opening of an Aircraft Cockpit Door in the Event That the Occupant or Occupants Improperly Do Not Grant Access and For Assuming Aircraft Control; and provisional application Ser. No. 62/172,407, filed Jun. 8, 2015 for “Means and Mechanism For The Remote Opening Of An Aircraft Cockpit Door In The Event That The Occupant Or Occupants Improperly Do Not Grant Access And For Assuming Aircraft Control Including Alternative Air Traffic Control Alert.

### BACKGROUND OF THE INVENTION

This invention relates generally to aircraft and more particularly to an emergency system for providing security to an in-flight aircraft by allowing access to the cockpit and/or assuming control of the flight path of the aircraft.

Safety of airplane in-flight crew and passengers often depends on preventing unauthorized access to the aircraft cockpit. Different technical means, personnel and safety measures are in existence for protecting the cockpit such as impregnable automatically self locking cockpit security doors and a keypad for entering an access code or procedures for personnel to announce the desire to enter the cockpit area through the locked cockpit security door. In some instances there are armed air marshals who are present incognito among the passengers in an attempt to protect the cockpit area and in particular instances where hostages are or may be taken and where terrorists are present. It is recognized by those skilled in the art that it is common to seal off and thus protect the cockpit of large commercial aircraft by a virtually impregnable separation wall that has a door in it through which crew members may enter or leave as such may be required from time to time. If the door is not electronically opened by the occupant or occupants of the cockpit when a party seeking access knocks, an entry code may be entered on a keypad on the passenger side of the separation wall which entry code when entered causes the door to open after a pre-set time delay during which time delay period the occupant of the cockpit can override the entry code signal by means of pulling or depressing a switch or button to keep the access door locked in the event that the occupant of the cockpit has reason to believe that terrorists or other improper parties are seeking access to the cockpit.

The present invention relates to a means and mechanism for the safe opening of an aircraft cockpit security door in the event that the occupant or occupants of the cockpit improperly refuse access because said occupant or occupants intend to suicidally crash or otherwise improperly direct the aircraft which invention has the following features:

A keypad on the passenger compartment side of the cockpit door having a second code for automatic transmission of a notification to all airline traffic controllers within transmission range that emergency access to the aircraft cockpit is needed.

One or more video cameras that can be mounted on the passenger compartment side of the aircraft cockpit door and in each of the passenger compartments that record and automatically transmit to all aircraft traffic controllers within range audio and video images of the area outside of the aircraft cockpit door and in the passenger compartments when the second code is entered on the cockpit door keypad.

A transmitter at each airline traffic control facility programmed to transmit a coded instruction to the auto-locking and auto-unlocking cockpit door control mechanism of the aircraft from which an emergency cockpit access transmission is received that causes said mechanism to override any contrary signal or other manual or automatic means of keeping the cockpit door locked from within the cockpit, which code causes the cockpit door control mechanism to unlock the cockpit door to provide access to the aircraft cockpit.

An additional computer on the aircraft having as an input, a receiver programmed to receive a code from an aircraft traffic control transmitter and having an output interface for an aircraft cockpit door electronic door lock which overrides any contrary electronic, automatic, or manual instruction or effort to keep the cockpit door locked from within the cockpit, and unlocks the cockpit door upon receipt of an unlock code transmission from any aircraft traffic control facility within transmission range.

In the event that undesirable activity is occurring in the cockpit and it is impossible to overcome such activity, an additional feature is provided for Air Traffic Control to be able to disable all control of the aircraft flight from the cockpit and to allow Air Traffic Control to assume complete control of the aircraft flight path.

To prevent intrusion into an aircraft cockpit by terrorists or others intent upon illegally seizing control of a commercial aircraft, locking cockpit doors have been installed that cannot be breached by a human if the door is locked. On the passenger side of said cockpit door, a keypad is situated for a party seeking access to the airline aircraft cockpit to enter a code that automatically causes the cockpit door to open after a delay of approximately 5 seconds or more. To prevent terrorists from obtaining and using the access code or forcing an occupant of the aircraft who knows the cockpit access code to enter the cockpit access code, thereby granting such parties improper access to the aircraft cockpit, a switch is situated in the aircraft cockpit which switch enables an occupant of the aircraft cockpit to override the access keypad and keep the cockpit door locked. This arrangement has created a problem whereby an occupant of the cockpit can keep the cockpit door locked and wrongfully cause the aircraft to suicidally crash or to be flown to an improper destination.

It is therefore an object of the present invention to create a means and mechanism for the remote opening of an aircraft cockpit door in the event that an occupant or occupants improperly do not grant access to the cockpit when such access is appropriate and necessary. Such access may be required when an occupant of the cockpit does not allow the cockpit door to be opened when necessary, or when an occupant of the cockpit physically overwhelms another occupant of the cockpit and then fails or refuses to open the cockpit door to permit proper access to the aircraft cockpit.

It is a further object of the present invention to provide the ability for Air Traffic Control to view the interior of the cockpit to determine if improper activity is occurring and, if so, to provide a means whereby the aircraft crew can disable any individual conducting such improper activity.

It is still a further object of the present invention to provide the ability for Air Traffic Control to assume complete control of the aircraft flight path when Air Traffic Control becomes aware that improper activity is occurring in the cockpit and such activity cannot be overcome.

This object is met according to the invention by enabling a party outside of the cockpit door to enter a second code, an emergency access code, into and by means of operating the access keypad on the outside of the cockpit door. The emergency access code thereby causes a transmitter on the aircraft to transfer a digital message to all Air Traffic Control facilities within transmission range indicating that immediate emergency access to the airline cockpit is required. An occupant of the Air Traffic Control facility would then be able to view the area on the passenger side of the cockpit door by means of a transmission to the Air Traffic Control facility of images and sound from digital video cameras situated both inside and outside of the cockpit access door and one or more cameras in the passenger compartment or compartments to determine whether it is safe and proper for the cockpit door to be opened and upon such a determination, the Air Traffic Controller could transmit a digital signal to the airline cockpit door control mechanism which overrides any contrary, digital, electronic or manual signal or endeavor to keep the cockpit door locked, thereby unlocking the cockpit door and granting access to the aircraft cockpit. There would also be a separate compartment adjacent to, but outside of, the cockpit door which houses a disabling device such as a Taser. The Air Traffic Control could send a digital signal permitting access to said separate compartment so that a crew member could retrieve the device and use it to disable the individual conducting the improper activity.

### SUMMARY OF THE INVENTION

A system for providing security of an in-flight aircraft comprising a plurality of video/audio cameras that could be automatically activated when the occupant or occupants of the cockpit pull an electronic switch or depress a button to override an access code signal sent by means of a person entering the access code on a keypad on the outside of the cockpit door, or when such party who has been denied access after entering the access code thereafter enters a second code which sends an electronic coded signal to all Air Traffic Control Facilities within transmission range of the aircraft that emergency access is required, video/audio cameras which cameras would then provide images of activity throughout the aircraft including galley, cockpit and passenger areas, thus providing a means for generating a coded signal for automatic transmission to all Air Traffic Control facilities within transmission range of the aircraft that emergency access to the aircraft cockpit is required, a transmitter at an Air Traffic Control facility that automatically becomes tuned to a frequency that is unique to the specific aircraft transmitting the emergency signal that generates a signal to activate the plurality of the video/audio cameras, a second transmitter on the aircraft for transmitting the video/audio signals generated to the Air Traffic Control facility for analysis by personnel at said facility and a signal generator in each of the Air Traffic Control facilities for generating a uniquely coded and time stamped signal which is different for each Air Traffic Control facility and is transmitted to and received by said aircraft when it is within transmission range of said Air Traffic Control facility to implement appropriate action responsive to the video/audio signals generated by the plurality of cameras.

### BRIEF DESCRIPTION OF THE DRAWINGS

FIG. 1 is a block diagram illustrating the various steps employed in carrying out the present invention;

FIG. 2 is a block diagram illustrating the manner in which Air Traffic Control obtains their required information;

FIG. 3 is a block diagram illustrating the compartment and the manner for permitting access thereto;

FIG. 4 is a block diagram illustrating assumption of the flight control path of the aircraft by Air Traffic Control; and

FIG. 5 is a block diagram illustrating an alternative means for alerting Air Traffic Control.

### DETAILED DESCRIPTION

When an authorized individual such as a pilot, copilot or flight attendant desires access to the cockpit of the aircraft he or she first knocks on the cockpit door, identifies himself or herself and requests entry. If entry is not provided, the individual then enters into the keypad at the cockpit door the required access code. The entry of the said access code causes the cockpit door to be unlocked after a delay of approximately five seconds or more. During said delay period, the occupant of the cockpit can depress a cockpit door lock control toggle switch or button which when depressed overrides the entered access code to keep the cockpit door locked for approximately twenty minutes or more to prevent would be hijackers or other potential wrongdoers from entering the cockpit. If access is denied by depression of said toggle switch or button in the cockpit, thus overriding the entered access code for a predetermined period of time such as twenty minutes and the individual desiring access believes that there is an emergency of some kind which requires entry by that person into the cockpit, that person can then enter an emergency access code into the cockpit door keypad such as indicated at 10. When that emergency access code is entered, the access door keypad then transmits a signal as indicated at 12 to a transmitter 14 which is activated. When the transmitter is activated, it generates a signal which is transmitted as shown at 16 on all frequencies for all Air Traffic Control facilities that are within the transmission vicinity of the aircraft. There will be contained within the transmitter 14 a computer 15 which is programmed to control the frequency of the transmitter 14 to the Air Traffic Control frequencies commensurate with the position of the aircraft which in turn will be determined by the typical location determination systems such as global positioning systems well known to those skilled in the art. When the transmitter 14 is thus activated and the emergency signal is transmitted and received by the Air Traffic Control facility it alerts the Air Traffic Control facility as shown at 18.

When the personnel in the Air Traffic Control facility are thus alerted by reception of the emergency signal transmitted by the transmitter 14, The Air Traffic Control personnel are also alerted as to the identity of the aircraft which is transmitting the emergency signal. The Air Traffic Control personnel then have at their facility an appropriate transmitter that is tuned to a frequency which will activate airborne cameras contained on the particular aircraft as illustrated at 20. When these cameras are activated, the Air Traffic Control personnel can view on monitors positioned within their facility the aircraft door and also the passenger areas of the aircraft to determine that there is no terrorist or other activity being conducted on the aircraft that should preclude the opening of the cockpit door. Under these circumstances, the Air Traffic Control personnel then are able to transmit an override signal to open the cockpit door as illustrated at 22 and such will be done.

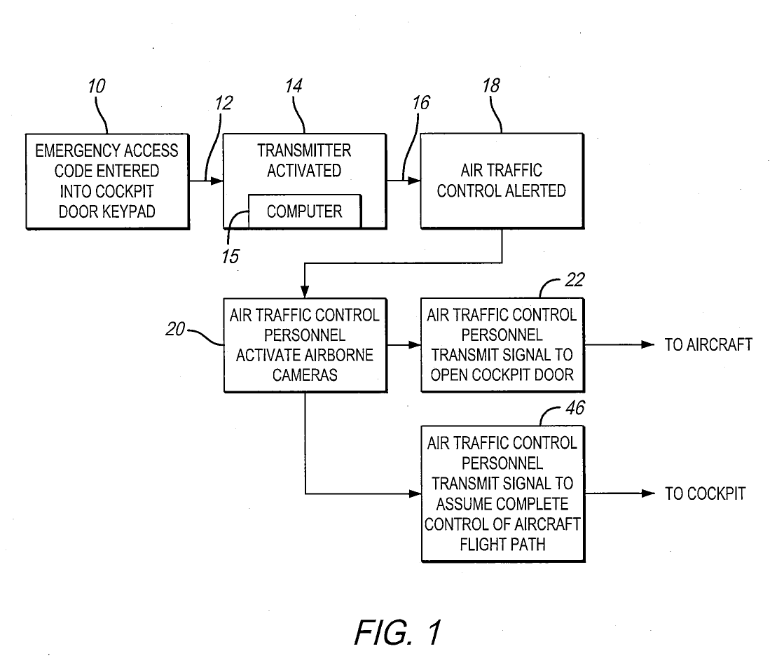

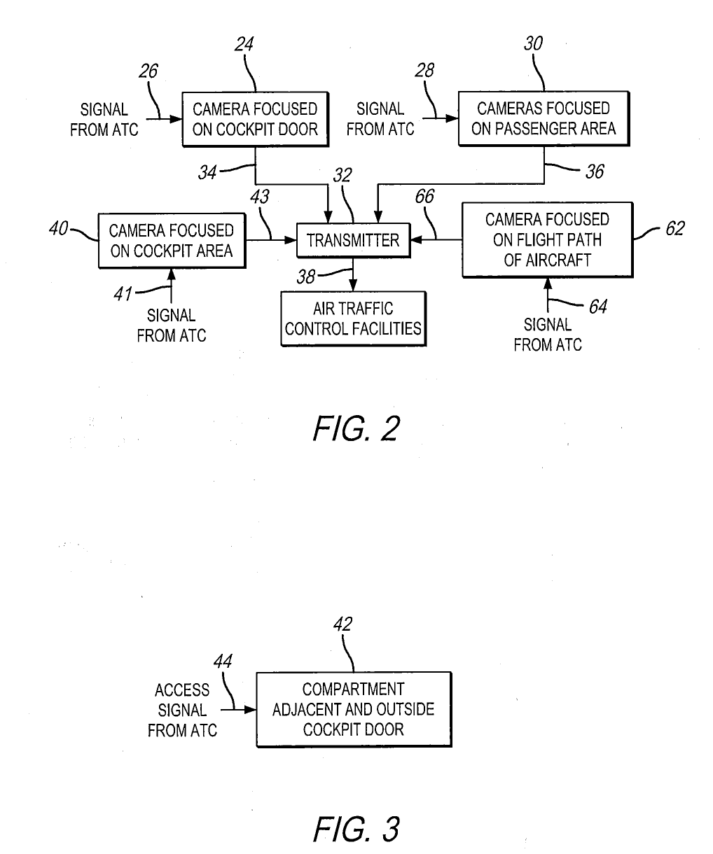

By reference to FIG. 2, the digital cameras focused on a cockpit door are shown at 24. These cameras are situated in positions on the aircraft so that they can clearly show with high resolution the cockpit door and the area surrounding it. It may be desirable to have more than one camera so focused on the cockpit door in the event that there is a failure of one of the cameras; thus there is redundancy provided. The camera focused on the cockpit door is activated by a signal from Air Traffic Control as indicated in FIG. 1 at 20 and also is illustrated at 26 in FIG. 2. As above indicated, it is important also that the Air Traffic Control personnel not only be able to view the area around the cockpit door, but also that they be able to view the area in the passenger compartments to be sure that there are not terrorists controlling the passengers within those areas in order to hijack the airplane or the like. As illustrated at 28, a signal from Air Traffic Control is transmitted to the aircraft as illustrated at 22 in FIG. 1 which activates the cameras 30 which are focused on the passenger areas of the aircraft. There will be several cameras so that the areas throughout the aircraft including first class, business class and economy can all be viewed by the individuals in the Air Traffic Control facility that has activated the airborne cameras. There can also be one or more cameras as indicated at 40 which is or are focused on the cockpit area to provide an unobstructed view of the cockpit occupant, the controls and the instruments. As shown at 41 a signal from Air Traffic Control is transmitted to the aircraft to activate the camera or cameras 40. When the cameras are activated, the digital signals generated by those cameras are forwarded to a transmitter 32 as indicated at 34, 36 and 43. These images are then transmitted as indicated at 38 to the Air Traffic Control facilities so that the personnel within the Air Traffic Control facilities can easily and quickly view the area around the cockpit door, inside the cockpit area and in the passenger areas of the aircraft to determine that there is no reason not to open the cockpit door. When the personnel at the Air Traffic Control facility are then fully satisfied that there is no reason not to open the cockpit door, even though access has been denied when the access signal was entered into the cockpit door keypad, then as indicated at 22 in FIG. 1, the Air Traffic Control facilities will transmit a new signal which overrides any contrary signal which has been entered in any manner either electronically or manually to keep the cockpit door locked. In addition, if the image from the cockpit camera 40 discloses that an individual in the cockpit area is conducting improper activity such as overpowering another individual or improperly flying the aircraft, Air Traffic Control may transmit a signal as shown at 44 in FIG. 3 to provide access to a compartment 42 located adjacent but outside the cockpit door. A disabling device such as a Taser is housed within the compartment 42 and can be removed by a crew member and used to disable the individual conducting the improper activity once the cockpit door has been opened as shown at 22 in FIG. 1.

As indicated above there is located in the cockpit a toggle switch which when placed in a first position will allow the cockpit door to be opened to permit entry of an authorized individual who has knocked and identified him or herself or who has appropriately entered the required code into the keypad on the cockpit door. As also indicated above, the toggle switch can be placed in a second position which will cause the door to the cockpit to remain closed and locked for a period of time such as twenty minutes. Under certain circumstances this has been utilized in order to prevent access to the cockpit and created a situation leading to a catastrophic event. As an alternative arrangement, to save precious time in an emergency situation, to prevent such catastrophic event from occurring, the system may be activated as illustrated in FIG. 5 to which reference is hereby made. As is therein shown at 62, when the toggle switch is placed in the lock position, a signal is automatically generated as shown at 64 to activate a transmitter as shown at 66 in the aircraft. The transmitter will be either the same as shown at 14 in FIG. 1 or an alternative transmitter as may be desired. This transmitter when activated will transmit a signal as shown at 68 which will be on all frequencies for all Air Traffic Control facilities that are within the transmission vicinity of the aircraft and if desired immediately activate all of the audio/video cameras contained on the aircraft as illustrated at 20 and immediately transmit the images and sound recorded by such cameras to all Air Traffic Control facilitates within transmission range. To accomplish this, as above indicated, there will be a computer in the activation mechanism for the transmitter which is programmed to control the frequency of the transmitter 66 to the Air Traffic Control frequencies commensurate with the position of the aircraft which in turn will be determined by the typical location determinable system such as Global Positioning System well known to those skilled in the art. When the transmitter 66 has thus been activated and transmits the signals shown at 68, the Air Traffic Control facility within the geographic location of the aircraft will be alerted as shown at 70. When the Air Traffic Control facility 70 is thus alerted, it will recognize that there is an emergency with regard to the particular aircraft which has been identified. The Air Traffic Control facility will then, through an appropriate transmission mechanism as shown at 72, generate and transmit a coded signal back to the aircraft. The signal which is thus generated by that particular Air Traffic Control facility has its own special and unique code which is utilized only by that Air Traffic Control facility and none other. It should be recognized by those skilled in the art that every Air Traffic Control facility will have its own special code assigned to it which is unique to that particular Air Traffic Control facility, that signal being transmitted as shown at 74. The signal being transmitted back to the aircraft will be received by the aircraft as shown at 76. The aircraft computer which receives the signal 74 will be programmed to accept the coded signal from the Air Traffic Control facility which is within the geographic location of the aircraft. Again, that geographic location will be determined by the Global Positioning System or the like which is located on the aircraft. It will be recognized by those skilled in the art that the computer is programmed such that the ability to receive signals from Air Traffic Control having a particular code assigned to that Air Traffic Control will be changed by the computer as the aircraft travels from position to position and is thus within the geographic region of the particular Air Traffic Control. Through the utilization of such uniquely coded signals for each of the Air Traffic Control facilities, a very secure system is thus implemented precluding terrorists or other unauthorized individuals from being able to obtain and utilize the signals improperly to open the cockpit security door of an aircraft.

Once the coded signal has been received and authenticated by the computer on the aircraft, that signal then will enable the Air Traffic Control to implement various activities above referred to such as activating the airborne cameras if they have not been automatically activated when access through the cockpit door has been electronically denied as aforementioned, ascertaining the activity that is occurring on the aircraft, provide access to the Taser or other disabling apparatus, override the lock on the aircraft door to permit entry, and if required, assuming control of the aircraft flight.

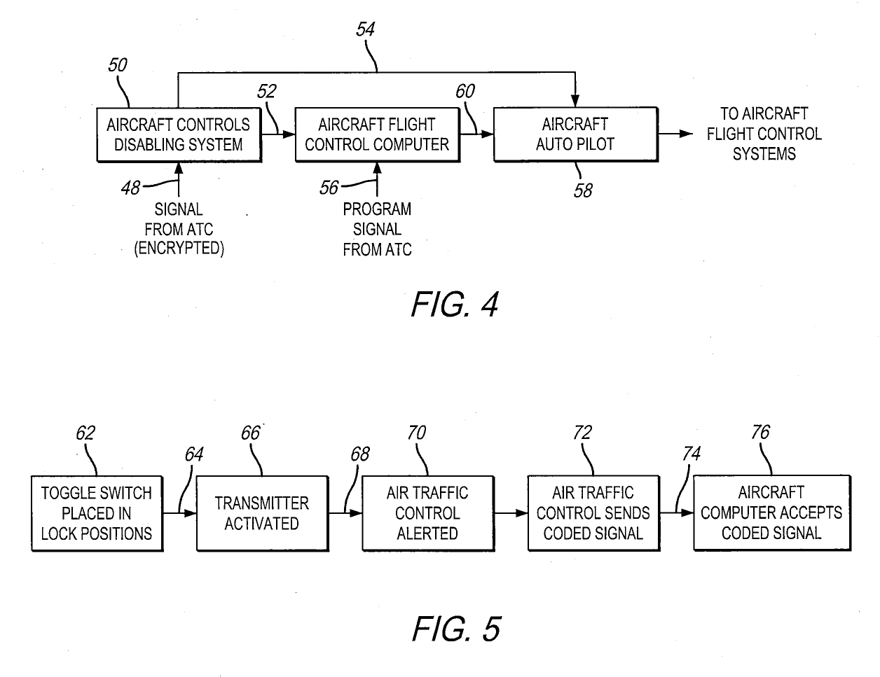

Under some circumstances even though the individual conducting the improper activity has been immobilized, the aircraft flight path may have already been programmed so that the aircraft is in danger or, alternatively, the individual conducting the improper activity cannot be immobilized or there may be no crew member on board the aircraft who is capable of assuming control of the aircraft after the individual conducting the improper activity has been immobilized. Under any of these circumstances, Air Traffic Control is provided with the ability to assume complete control of the aircraft flight path. This is accomplished as is shown in FIG. 1 after the aircraft control personnel have activated the airborne cameras or they have been automatically activated as shown at 20 and Air Traffic Control has determined by viewing the signals from the cameras as illustrated at FIG. 2 and particularly the signals generated by the camera focused on the cockpit area 40 that control of the aircraft flight control path needs to be assumed. Under these circumstances, the Aircraft Traffic Control personnel can transmit an encrypted signal to assume complete control of the aircraft flight path as shown at 46 in FIG. 1. The assumption of the aircraft flight control path by the Air Traffic Control facility is illustrated in block diagram form in FIG. 4 to which reference is hereby made. As is therein shown, the encrypted signal generated by Air Traffic Control as indicated at 46 in FIG. 1 will be transmitted as illustrated at 48 to an aircraft controls disabling system 50 which will generate a signal that is transmitted to the Aircraft Flight Control Computer as shown at 52 and to the Aircraft Auto Pilot as shown at 54 which will totally disable the ability of the internal control system contained in the cockpit from controlling the flight path of the aircraft. After disabling the ability of the internal controls either manually or through the computer system from controlling the aircraft, the Air Traffic Control personnel will have the ability to generate a signal as indicated at 46 in FIG. 1 to program the aircraft flight control computer which is indicated at 56. This signal operates independently from any signals initiated internally in the cockpit of the aircraft and overrides any such signals that may have been previously generated and inputted into the aircraft flight control computer. This will enable Air Traffic Control to generate a flight path for the aircraft to the nearest airport that will be able to receive the aircraft. The program from Air Traffic Control will also cause signals to be transmitted to the aircraft auto pilot 58 as shown at 60 which will operate the aircraft control system in accordance with commands from the aircraft flight control computer to cause the aircraft flight path to be appropriate. These signals would include taking the aircraft to an appropriate altitude to avoid any terrain issues that may occur. This can be accomplished because Air Traffic Control, through the signals received from the aircraft transponder will know exactly where the aircraft is and thus will be able to program the flight control computer to avoid any obstacles that may exist.

In addition to the foregoing, Air Traffic Control will be able to insert the position coordinates of the nearest airport which can receive the aircraft safely to avoid damage to the aircraft or injury to its passengers. If the aircraft has an automatic landing system (Autoland) and there is an airport in the general vicinity of the aircraft which is Autoland enabled, then the Air Traffic Control program signal as shown at 56 would direct the aircraft auto pilot to fly the airplane to that particular airport and to engage with the Autoland to bring the aircraft automatically, without input from the cockpit, into the airport and safely land it. In the event that the aircraft does not have Autoland or there is no airport in the vicinity that has the Autoland technology, then the aircraft would be directed to the nearest airport which has an instrument landing system (ILS). Under these circumstances, it will be required for the Air Traffic Control personnel to be able to view the flight path of the aircraft. In order to accomplish this, there is a camera focused on the flight path of the aircraft that is positioned on the aircraft to accomplish this. This camera is illustrated at 62 in FIG. 2. A signal from Air Traffic Control as shown at 64 would activate this camera when such becomes necessary as determined by Air Traffic Control personnel. After the camera has been activated, the signal from the camera 66 would be transmitted to the transmitter as shown in FIG. 2 and the signal would be forwarded to the Air Traffic Control facility. Under these circumstances, the Air Traffic Control personnel would then be able to view the flight path of the aircraft. When the aircraft approaches the airport having the instrument landing system, the aircraft flight control computer and the aircraft auto pilot would be synced to receive the ILS glide path and azimuth control signals causing the aircraft to be able to make the desired approach into that particular airport. With no Autoland at the airport, the Air Traffic Control personnel viewing the flight control path, as a result of the signals from the camera at 62, would be enabled to view the runway area of the airport and in combination with communication by radio from the tower at the particular airport of concern would be able to know when the power for the aircraft engines are to be reduced and flaps and spoilers are to be extended and when such information becomes available to the Air Traffic Control personnel, the personnel could again program the aircraft flight control computer as shown at 56 in FIG. 4 to accomplish the desired power controls, the lowering of the aircraft landing gear and the extension of the flaps and spoilers to place the aircraft in the proper condition for a landing at the airport with the instrument landing system.

There has thus been disclosed a system for the safe opening of an aircraft cockpit door in the event that the occupant or occupants of the cockpit have in some fashion generated a signal or manually employed a means to keep the cockpit door locked even though the required access code has been entered into the cockpit door keypad, and/or the safe remote operation of the aircraft flight control path in the event such otherwise becomes necessary.

What is claimed is:

1. A system for providing security of an in-flight aircraft comprising:
(A) a plurality of video/audio cameras disposed to provide images of activity in the passenger, galley and cockpit areas of the aircraft;
(B) a keypad on the passenger side of the cockpit security door for generating a coded signal for automatic transmission to all Air Traffic Control facilities within transmission range of the aircraft that emergency access to the aircraft cockpit is required;
(C) a first transmitter on said aircraft which is activated by said coded signal to transmit the signal to all the Air Traffic Control facilities;
(D) a transmitter at said Air Traffic Control facility tuned to a frequency that is unique to the specific aircraft transmitting the emergency signal for generating a signal to be received by said aircraft to activate said plurality of video/audio cameras;
(E) a second transmitter on said aircraft for transmitting the video/audio signals generated by said plurality of video/audio cameras to said Air Traffic Control facility for analysis by personnel at said Air Traffic Control facility to determine the nature of the emergency; and
(F) a signal generator at each of said Air Traffic Control facilities for generating a uniquely coded and time stamped signal which is different for each Air Traffic Control facility and is transmitted to and received by said aircraft when in transmission range of said Air Traffic Control facility to implement appropriate action responsive to the analysis by the Air Traffic Control personnel of the video/audio signals generated by said plurality of cameras.

2. A system as defined in claim 1 which further includes a signal generator on said aircraft which automatically produces an emergency access to the cockpit signal which is transmitted to all Air Traffic Control facilities within transmission range of the aircraft when a switch in the cockpit has been placed in a position to preclude access to the cockpit through normal security protocols.

3. A system as defined in claim 1 which further includes a separate compartment on the passenger side of the cockpit door containing a disabling device, the time stamped signal from the Air Traffic Control facility permitting access to said compartment to allow a crew member to use the disabling device to use it to further secure the aircraft.

4. A system as defined in claim 1 wherein said time stamped signal generated by said Air Traffic Control facility is encrypted and disables the normal internal aircraft control system contained in the cockpit, assumes control of the aircraft flight control computer and autopilot thereby allowing personnel at the Air Traffic Control facility to assume control of the aircraft flight control path.

5. A system as defined in claim 4 wherein assumption of the aircraft flight control path includes safely landing the aircraft at an airport equipped with an instrument landing system including an Autoland system.

6. A system as defined in claim 5 which further includes an additional camera focused on the flight path of the aircraft to be activated by the Air Traffic Control facility to enable the Air Traffic Control facility personnel to control the aircraft flight control path to safely land the aircraft.

7. A system as defined in claim 2 wherein said time stamped signal overrides any signal which has been created to keep the cockpit door locked thereby allowing access to the cockpit by appropriate crew members.

8. A system as defined in claim 3 wherein the disabling device is a Taser.

9. A system as defined in claim 1 which further includes a computer on said aircraft programmed to receive the unique coded time stamped signal from each Air Traffic Control facility as the aircraft passes through a transmission reception region of each Air Traffic Control facility.

10. A system as defined in claim 1 which further includes a signal generator for the automatic transmission of a signal to immediately activate said plurality of video/audio cameras as and when an occupant of the cockpit depresses a switch or button to override a cockpit access signal activated by entry of an access code on the keypad on the passenger compartment side of the cockpit security door.
